(19) United States
(12) Patent Application Publication
(10) Pub. No.: US 2010/0018158 A1
(43) Pub. Date: Jan. 28, 2010

(54) Screwing head for screwing the ring nut of a small trigger-type pump on a vessel

(75) Inventor: Renzo Vesentini, Marmirolo (IT)

Correspondence Address: HEDMAN & COSTIGAN P.C., 1185 AVENUE OF THE AMERICAS, NEW YORK, NY, 10036, US

(73) Assignee: REJVES S.R.L., Marmirolo (MN) (IT)

(21) Appl. No.: 11/919,186

(22) PCT Filed: May 9, 2006
(86) PCT No.: PCT/EP2006/004300

§ 371 Date: Oct. 24, 2007

(30) Foreign Application Priority Data
May 19, 2005 (IT) PR2005A000024

(51) Int. Cl. B67B 3/20

(52) U.S. Cl. 53/317

(57) ABSTRACT

The invention deals with the field of screwing heads for small trigger-type pumps or triggers and namely for applying, on vessels, triggers equipped with a threaded securing ring nut (2). This screwing head (1) is rotated around a vertical axis through a permanent magnet-type clutch and comprises four rollers (5) which tighten the toothed ring nut (2) when screwing it; said rollers (5) are supported by vertical arms (4) whose axes are arranged at 90° one from the other on a circumference with its centre on the rotation axis of the screwing head. The vertical arms (4) and the four rollers (5) are simultaneously carried along a radial direction towards said ring nut through an oscillating movement.

The present invention deals with a screwing head for screwing the ring nut of a small trigger-type pump, commonly called trigger, on a vessel.

As known, a trigger is equipped with a float composed of a small pipe aimed to be inserted into the vessel, further comprising an externally toothed ring nut which is free of rotating with respect to the trigger body and is internally threaded to be associated with the corresponding threading obtained on the vessel neck to be plugged.

The screwing head is used in connection with a carousel-type (rotating) or a linear-type machine and, next to every machine workstation, a washer is provided which supports the vessel to be screwed, while the screwing head comprises clamping means of the trigger ring nut which screw it onto said vessel.

The head is actuated by a cam which handles a slide which lowers the clamping means, generally composed of a pair of rollers which are kinematically connected through two arms with the motoring device of the screwing head so that, once arranged in contact with the ring nut, they screw it onto the vessel.

Following the tightening, to avoid that the torque impressed onto the head exerts an action which is greater than the threading sealing limit, a permanent magnet-type clutch takes care of detaching the rotation action to the rollers.

A prior art inconvenience which uses only two tightening rollers, is that, to avoid sliding between these latter ones and the knurled ring nut, a certain energic action must be created, namely a certain pressure onto the ring nut, creating distortions and abrasions thereon.

A prior art proposed solution to solve the above inconvenience has been doubling the number of rollers acting on the ring nut in order to reduce the local contact pressure, though keeping unchanged the number of oscillating arms for approaching the ring nut; this solution modifies the operating angle of each roller onto the ring nut (not radial any more) at the same time creating slidings between components and unpleasant abrasions to the knurled part of the ring nut.

Object of the present invention is removing the above inconveniences by providing a screwing head for trigger which enables an optimum ratio of the operating pressures between rollers and ring nut and allows keeping a suitable operating angle between the two components.

These objects and advantages are all obtained by the screwing head for trigger, which is the subject matter of the present invention, which is characterised in what is included in the claims which follow.

Characteristics and advantages will be better pointed out by the following description of a preferred embodiment, shown merely as a non-limiting example, in the attached tables of drawing, in which:

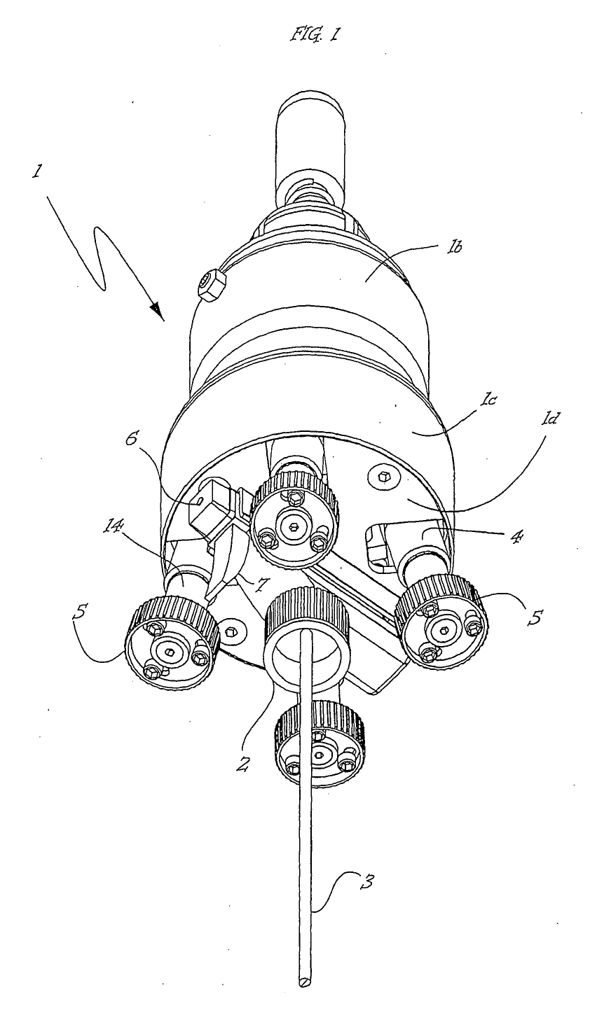

FIG. 1 shows a perspective view of the screwing head for triggers in a configuration with open rollers;

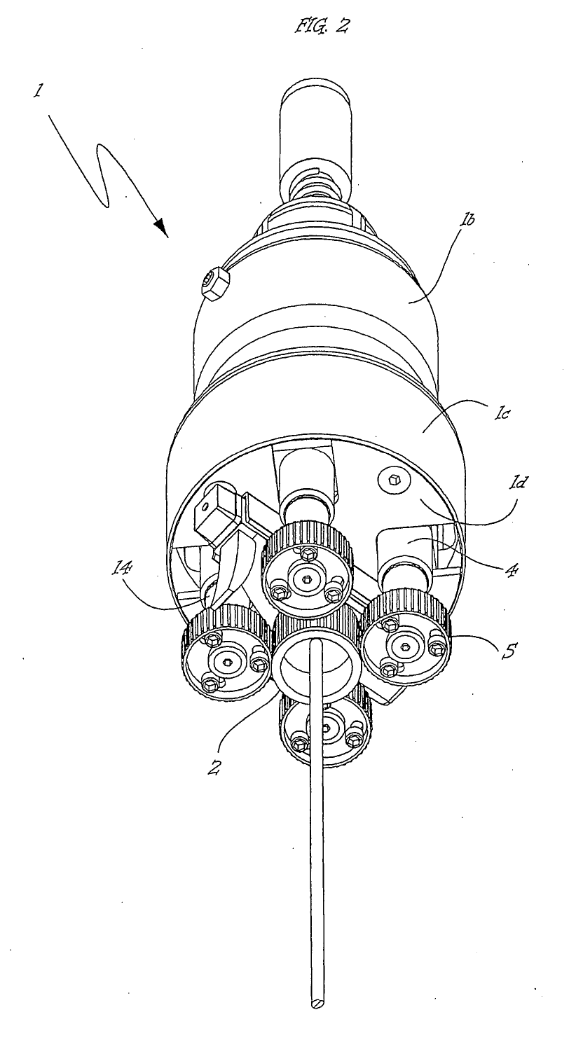

FIG. 2 shows the screwing head for triggers in a configuration with tightened rollers around the ring nut of a trigger;

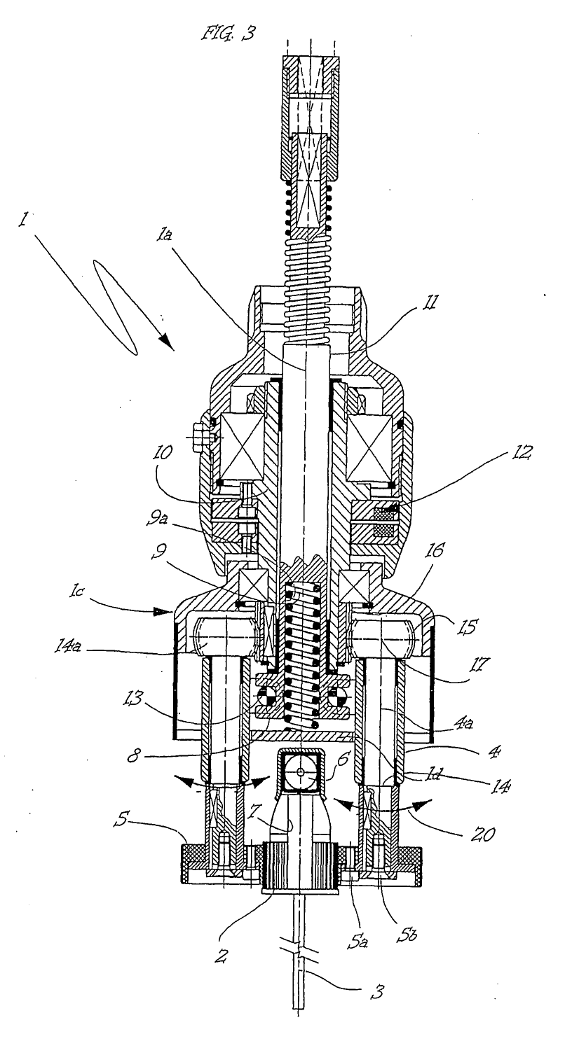

FIG. 3 shows the screwing head in a medium section of FIG. 2.

With reference to FIG. 1 a screwing head 1 is shown as a whole; under it, a trigger 6 is located, equipped with a ring nut 2, which will be screwed onto a vessel, not shown.

The trigger, of a known type, further comprises the control lever or trigger 7 and the floating cannula 3; the ring nut 2 is internally threaded to be screwed onto the vessel neck and externally has a toothed or knurled crown.

The screwing head 1 is rotated around a vertical axis 1a and comprises four vertical arms 4, each one carrying a (toothed or knurled) roller 5.

Precisely, the vertical axes 4a of the four arms 4 are located 90° one to the other, on a circumference with its centre on the vertical rotation axis 1a.

The four vertical axes 4a can simultaneously oscillate in order to bring the four rollers from an open position, FIG. 1, to a tightening position around the ring nut of the trigger, as shown in FIGS. 2 and 3.

The configuration normally assumed by the screwing head is the open one, namely the one related to the device rest phase, such phase preceding the tightening of the ring nut 2 onto the vessel.

The system which allows bringing the rollers 5 from a rest position to their tightening position will now be described.

This screwing head 1 is composed of an upper body 1b and a lower bell 1c rotating together around the rotation axis 1a through a permanent magnet-type clutch 12, inserted in the upper body 1b, which rotates, through the below described kinematism, the rollers 5 around the axis 4a.

An hollow shaft 10 is inserted in the upper body and in the lower bell through suitable bearings.

Inside the hollow shaft 10 a stem 11 is housed, which can vertically translate along axis 1a moved by a cam kinematism of a known type and not shown in the figure.

It follows that, while the hollow shaft 10 rotates, the stem 11 will be free of sliding inside it, recalled by the mentioned cam.

The terminal part of the stem 11, namely the one towards a base 1d for closing the bell 1c, ends with four forks 8 with four recesses which allow housing as many pins 13 which are part of the previously described arms 4.

A spring 9 is placed in a hole 9a of the stem 11 and abuts against the base 1d in order to keep said stem in contact with the corresponding control cam (not shown) and its function is guaranteeing a radial pressure onto the ring nut.

When the cam pushes the stem 11 downwards, the fork 8 drags each pin 13 being an integral part of the arm 4, and the arm 4 hinged in the point 17, an oscillation of each roller 5 follows, around said point 17 as pointed out by reference 20.

The stem 14 is connected with the hollow shaft 10 through a toothed kinematism, since on the end part of the hollow shaft 10, a toothed crown 16 is keyed, which engages a corresponding ball-shaped toothing 15 obtained on a bulb 14a of the stem 14 (opposite to the end part connected to the roller 5).

It follows that the translation action given by the stem 11 impresses a rotation to the stem 14, since it is dragged by the corresponding arm 4.

This will make the rollers 5 radially open, which in such a way will be detached from the ring nut 2.

The clutch is engaged for detaching from the hollow shaft 10 and therefore stopping the torque provided to the rollers 5 and the ring nut 2, avoiding to damage the threaded connection and the ring nut 2.

Summarising, a plugging head 1 is available for a trigger having four rollers 5 simultaneously moved along a radial direction, and from four different points of the screwing head, towards the ring nut 2 of the plug which will have to be screwed onto the vessel.

The action is imparted through the combination of a rectilinear movement of the stem 11 which directly operates on the arms 4 and of a rotation of the stem 14, inside the arm 4, performed with the above cited toothed kinematism between toothing 16 of the hollow shaft 10 and toothing 15 of the bulb 14a.

The stem 11 is driven by a cam, while the action of keeping the position is guaranteed by a thrust spring 9 placed in the opposite direction.

Obviously, the radial displacement of the four rollers in order to go into the crown tightening position can be realised with other kinematisms adapted to make the rollers intervene radially towards the rotation axis of the ring nut, without departing from the scope of the below listed claims.

Moreover, the four rollers 5 can be arranged on a circumference with its centre on the rotation axis at a variable angular distance from the previously described one, though keeping the concept of simultaneous radial displacement, namely the vertical axes 4a of the four arms 4 will be able to be arranged at different angles on the circumference with its centre on the vertical rotation axis 1a.

1. Screwing head (1) for screwing a ring nut (2) of a trigger on a vessel comprising rollers (5) which tighten said ring nut (2) when screwing the nut to the vessel, said rollers (5) being movable from a rest position to a tightening position and all oscillating with respect to a vertical axis (1a) of the screwing head (1), since their fulcrum is on their own oscillation point (17), characterised in that it comprises four rollers (5) with substantially vertical axes arranged on a circumference with its centre on the vertical axis (1a) and each of the four rollers (5) is motorized and moved along a radial direction towards said ring nut (2).

2. Screwing head (1), according to claim 1, characterised in that it comprises a hollow shaft (10), coaxial with the vertical axis (1a), in which a stem (11) is inserted which is free of translating along the axis (1b) direction through a cam kinematism, said stem being kinematically connected to four vertical arms (4) carrying the rollers (5).

3. Screwing head (1), according to claim 1, characterised in that the radial approaching action of the rollers (5) is imparted through the combination of a rectilinear movement of the stem (11) which directly operates on the arms (4) and of a rotation of the stem (14), inside the arm (4), around its own rotation axis (4a); said rotation being performed through a toothed kinematism comprising a toothed crown (16) keyed on the end part of the hollow shaft (10) and a corresponding ball-type toothing (15) obtained on the bulb (14a) of the stem (14).

4. Screwing head (1), according to claim 1, characterised in that the end part of the stem (11), facing towards the closing base (1d) of the lower bell (1c), ends with four forks (8) with four recesses which allow housing as many pins (13) which are part of the arms (4) in order to allow their movement through the stem (11) in the oscillation point (17).

5. Screwing head (1), according to claim 1, characterised in that the vertical axes (4a) of the four arms (4), namely the rollers (5), are placed at 90° one from the other, along a circumference with its centre on the vertical rotation axis (1a).

6. Screwing head (1), according to claim 1 and 5, characterised in that the vertical axes (4a) of the four arms (4), namely the rollers (5), are placed on a circumference according to a variable angular distance.
